(19) United States
(12) Patent Application Publication
(10) Pub. No.: US 2019/0232908 A1
(43) Pub. Date: Aug. 1, 2019

(54) SYSTEMS AND METHODS FOR ACCIDENT MANAGEMENT FOR VEHICLES

(71) Applicant: Noodoe Corporation, Taipei City (TW)

(72) Inventor: John C. Wang, Taipei City (TW)

(21) Appl. No.: 16/263,294

(22) Filed: Jan. 31, 2019

(30) Foreign Application Priority Data
Jan. 31, 2018 (TW) 107103345

(51) Int. Cl. B60R 21/0132; G08G 1/01; G07C 5/00; H04W 4/02; H04W 4/40

(52) U.S. Cl. CPC B60R 21/0132; G08G 1/0112; B60R 2021/0027; H04W 4/027; H04W 4/40; G07C 5/008

(57) ABSTRACT

Systems and methods for accident management for vehicles for use in an identification device set on a vehicle and a smartphone are provided. First, a motion or posture of the identification device is detected via at least one motion sensor of the identification device. When the detected data indicates that a collision is present by the vehicle, the identification device transmits a trigger signal to the smartphone via a wireless network. In response to the trigger signal, an accident notification process is performed by using a notification component of the smartphone.

### BACKGROUND OF THE INVENTION

### Field of the Invention

The disclosure relates generally to systems and methods for accident management for vehicles, and, more particularly to systems and methods for accident management for vehicles that can automatically perform an accident notification process using a smartphone and an identification device set on the vehicle.

### Description of the Related Art

With the coming of IOT (Internet Of Things) generation, every device or object can connect to networks, and users can access and control these devices or objects via networks. The rapid development of IOT is fortunate that the underlying foundation of wireless network technology is already very mature. Electronic devices can readily connect with each other to perform related applications via wireless networks. Additionally, the BLE (Bluetooth Low Energy) technology has solved the prohibitive power consumption issue caused by prolonged connections of electronic devices to wireless networks. For example, a beacon device is a low-cost wireless Bluetooth transmitter implemented with BLE technology, which can transmit Bluetooth signals via a wireless network for a long time. Currently, a large number of beacon devices and innovative applications have been developed and used.

On the other hand, with the development of electronic technology, many automobile electronics have been developed to bring more convenient applications and intelligent to vehicles. For example, a Beacon device can be designed to replace a key of a vehicle and the user can carry the Beacon device. Once the vehicle detects that the Beacon device is approaching the vehicle, the user can directly press the start button set on the vehicle to start the car. In general, vehicles usually do not have communication capabilities. In other words, the vehicles cannot communicate with external devices autonomously. In some conventional services, a vehicle may install a SIM card of a telecommunications company to solve the problem of external communication. However, due to the installation of the SIM card, it is necessary to pay the telecommunications company related expenses, such as monthly fees. Therefore, the cost issue also reduces the user's willingness to use the aforementioned services.

Recently, electronic devices, such as smart phones, notebooks, wearable devices and other portable devices, have become more and more technically advanced and multifunctional. For example, portable devices have network connectivity capabilities. Users can use their portable devices to connect to networks to browse the Internet at anytime and anywhere. The convenience and new functionalities advanced by modern technology have made these devices into necessities of life, and they are frequently used in life at anytime and anywhere. If the communication function of the electronic device, such as the smartphone, can be fully utilized to perform related managements of vehicle communication, the aforementioned disadvantages can be reduced.

### BRIEF SUMMARY OF THE INVENTION

Methods and systems for accident management for vehicles are provided, wherein an accident notification process is automatically performed using a smartphone and an identification device set on the vehicle.

An embodiment of a system for accident management for vehicles comprises an identification device set on a vehicle and a smartphone. The identification device comprises a first wireless network connecting unit, at least one motion sensor and a controller. The controller determines whether a collision is present by the vehicle according to the data detected by the motion sensor. The controller transmits a trigger signal via a wireless network using the first wireless connecting unit when the detected data indicates that the collision is present by the vehicle. The smartphone comprises a second wireless network connecting unit, a notification component, and a processor. The processor receives a trigger signal through the wireless network using the second wireless network connecting unit. The processor performs an accident notification process by using the notification component in response to the trigger signal.

In an embodiment of a method for accident management for vehicles for use in an identification device set on a vehicle and a smartphone, a motion or posture of the identification device is detected via at least one motion sensor of the identification device. It is then determined whether a collision is present by the vehicle according to the data detected by the motion sensor. When the detected data indicates that a collision is present by the vehicle, a trigger signal is transmitted to the smartphone via a wireless network by the identification device. In response to the trigger signal, an accident notification process is performed by using a notification component of the smartphone.

In some embodiments, the notification component comprises a specific network connecting unit. The accident notification process is performed by using the specific network connecting unit to transmit an accident message through a network to a specific trusted terminal.

In some embodiments, the notification component comprises a telecommunications module. The accident notification process is performed by using the telecommunications module to make a specific call or transmit a specific message to a specific trusted terminal through a telecommunications network.

In some embodiments, wherein the processor of the smartphone performs a countdown process when receiving the trigger signal from the identification device through the wireless network, and uses the notification device to perform the accident notification process after the countdown process is ended. In some embodiments, the processor of the smartphone further displays the countdown process through a user interface by using a display unit, determines whether an interrupt indication is received before the end of the countdown process, and cancels the accident notification process when the interrupt indication is received before the end of the countdown process.

In some embodiments, the smartphone further comprises a positioning unit, and the processor of the smart phone uses the positioning unit to obtain current location when receiving the trigger signal from the identification device through the wireless network, and performs the accident notification process using the notification component according to the current location.

Methods for accident management for vehicles may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for accident management for vehicles of the invention;

FIG. 2 is a schematic diagram illustrating an embodiment of an identification device of the invention;

FIG. 3 is a schematic diagram illustrating an embodiment of a smartphone of the invention;

FIG. 4 is a flowchart of an embodiment of a method for accident management for vehicles of the invention;

FIG. 5 is a flowchart of another embodiment of a method for accident management for vehicles of the invention;

FIG. 6 is a flowchart of an embodiment of a method for accident notification of the invention;

FIG. 7 is a flowchart of another embodiment of a method for accident notification of the invention;

FIG. 8 is a flowchart of another embodiment of a method for accident management for vehicles of the invention; and

FIG. 9 is a flowchart of another embodiment of a method for accident management for vehicles of the invention.

### DETAILED DESCRIPTION OF THE INVENTION

Methods and system for accident management for vehicles are provided.

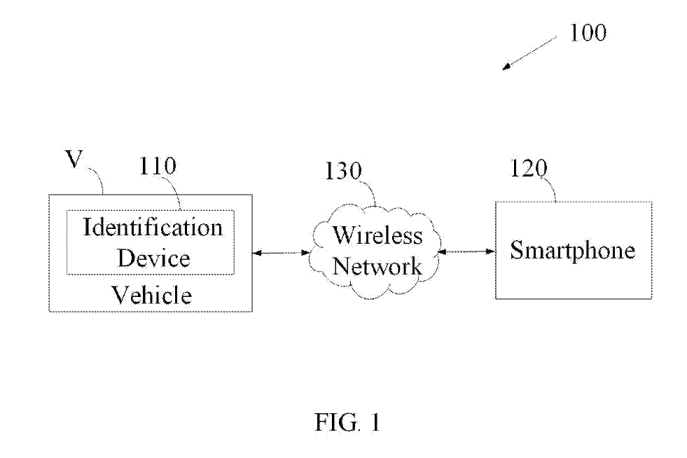

FIG. 1 is a schematic diagram illustrating an embodiment of a system for accident management for a vehicle of the invention. As shown in FIG. 1, the system for accident management for a vehicle 100 comprises an identification device 110 set on a vehicle V, such as a motorcycle or a car, and a smartphone 120. The identification device 110 and the smartphone 120 can be coupled to each other via a wireless network 130, such as Wi-Fi or Bluetooth network.

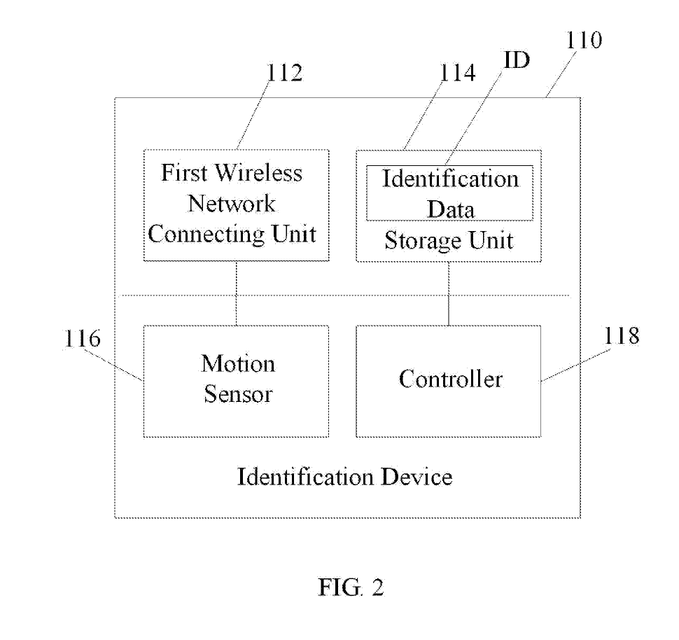

FIG. 2 is a schematic diagram illustrating an embodiment of an identification device of the invention. As shown in FIG. 2, the identification device 110 comprises a first wireless network connecting unit 112, a storage unit 114, at least one motion sensor 116, and a controller 118. The first wireless network connecting unit 112 can have a network access capability for connecting to other electronic devices having wireless connecting capabilities via a wireless network, such as Wi-Fi or Bluetooth network. It should be noted that, in some embodiments, the first wireless network connecting unit 112 may be a network connecting unit implemented with a low-power consumption technology, such as Bluetooth Smart technology. The first wireless network connecting unit 112 has two modes, specifically a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the first wireless network connecting unit 112 is in the peripheral mode. In other words, the first wireless network connecting unit 112 has data broadcasting capabilities, and the first wireless network connecting unit 112 cannot actively connect to other electronic devices, wherein the wireless network connecting unit 112 can be passively connected to other electronic devices. The storage unit 114 can store identification data ID corresponding to the identification device 110. In some embodiments, the identification device 110 can broadcast the identification data ID using the first wireless network connecting unit 112. Other electronic devices can be connected to the identification device 110 through the identification data ID. The motion sensor 116 can detect a posture and/or motion of the identification device 110 and/or the vehicle V. For example, the motion sensor 116 may be an accelerometer for generating information of velocity and displacement when the identification device 110 moves. In another example, the motion sensor 116 may be a Gyro sensor for generating information of angular acceleration when the identification device 110 moves. In another example, the motion sensor 116 may be an e-compass for detecting an angle of the identification device 110 in regard to a geographical direction, such as the direction of the North Pole or the South Pole. It is noted that, the above sensors are only examples of the present application, and the present invention is not limited thereto. Any sensor that can detect the posture and/or motion of the identification device 110 can be applied in the present invention. As described, the motion sensor 116 can detect the posture of the identification device 110. It is understood that, in some embodiments, the posture can be the angular information of the identification device 110 in regard to at least one reference point. In some embodiments, the posture of the identification device 110 can be represented by an angle corresponding to an axis which is vertical to at least one plane of the identification device 110 in regard to a specific direction, such as the gravity direction or the geographical direction. The controller 118 can control related operations of software and hardware in the identification device 110, the details of which will be described later.

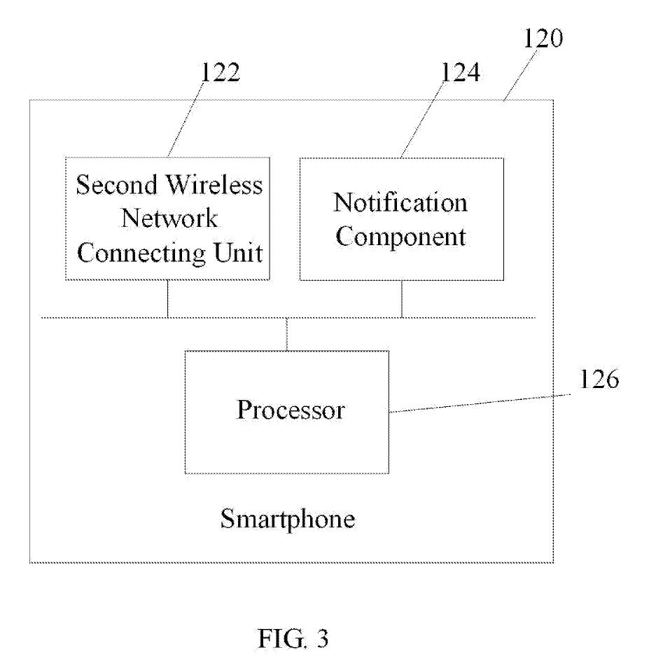

FIG. 3 is a schematic diagram illustrating an embodiment of a smartphone of the invention. As shown in FIG. 3, the smartphone 120 comprises a second wireless network connecting unit 122, a notification component 124, and a processor 126. The second wireless network connecting unit 122 can have a network access capability for connecting to other electronic devices having wireless connecting capabilities via a wireless network, such as Wi-Fi or Bluetooth network. It should be noted that, in some embodiments, the second wireless network connecting unit 122 may be a network connecting unit implemented with a low-power consumption technology, such as Bluetooth Smart technology. The second wireless network connecting unit 122 has two modes, specifically a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the second wireless network connecting unit 122 is in the central mode. The notification component 124 can be any component that can notify an incident/event. It should be noted that, in some embodiments, the notification component 124 may include a specific network connecting unit for connecting to the Internet. In some embodiments, the notification component 124 can include a telecommunications module for connecting to a telecommunications network of a telecom service provider. It is noted that, the above notification component 124 are only examples of the present application, and the present invention is not limited thereto. The processor 126 can control the operations of related software and hardware in the smartphone 120, the details of which will be described later. It should be noted that, in some embodiments, the smartphone 120 may further include a display unit (not shown in FIG. 3) for displaying related data, such as images, interfaces, information, and so on. In some embodiments, the smartphone 120 may include a positioning unit (not shown in FIG. 3) for communicating with at least one satellite to obtain the location, such as latitude and longitude coordinates, corresponding to the smart phone 120. In some embodiments, a specific location may be obtained based on the location obtained by the positioning unit and map data.

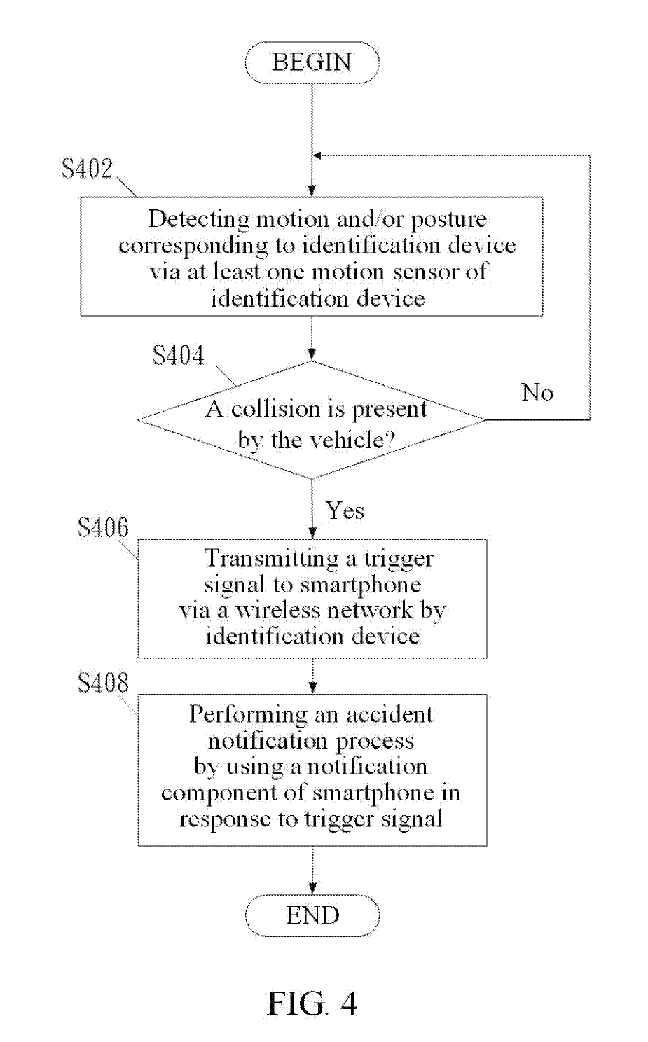

FIG. 4 is a flowchart of an embodiment of a method for accident management for vehicles of the invention.

First, in step S402, a motion and/or a posture corresponding to the identification device is detected via at least one motion sensor of the identification device. It should be noted that, in some embodiments, the motion sensor may be an accelerometer for generating information of velocity and displacement when the identification device moves. In some embodiments, the motion sensor may be a Gyro sensor for generating information of angular acceleration when the identification device moves. In some embodiments, the motion sensor may be an e-compass for detecting an angle of the identification device in regard to a geographical direction, such as the direction of the North Pole or the South Pole. It is noted that, the above sensors are only examples of the present application, and the present invention is not limited thereto. Any sensor that can detect the posture and/or motion of the identification device can be applied in the present invention. As described, the motion sensor can detect the posture of the identification device. It is understood that, in some embodiments, the posture can be the angular information of the identification device in regard to at least one reference point. In some embodiments, the posture of the identification device can be represented by an angle corresponding to an axis which is vertical to at least one plane of the identification device in regard to a specific direction, such as the gravity direction or the geographical direction. It is noted that, since the identification device is set on the vehicle, the motion and/or posture of the vehicle directly affects the motion and/or posture of the identification device. In step S404, it is determined whether a collision is present by the vehicle according to the data detected by the motion sensor. It is noted that, in some embodiments, a threshold can be set in the motion sensor. When the data detected by the motion sensor is greater than the threshold, it can be determined that a collision is present by the vehicle. When the detected data indicate that a collision is not present by the vehicle (No in step S404), the procedure returns to step S402. When the detected data indicate that a collision is present by the vehicle (Yes in step S404), in step S406, the identification device transmits a trigger signal to the smartphone via a wireless network. It should be noted that, in some embodiments, a connection between the smartphone and the identification device can be established through a wireless network. It should be noted that, in some embodiments, the identification device can broadcast its identification data through the wireless network, and the smartphone can establish a connection with the identification device through the wireless network according to the identification data corresponding to the identification device. Next, in step S408, in response to the trigger signal, an accident notification process is performed by using a notification component of the smartphone.

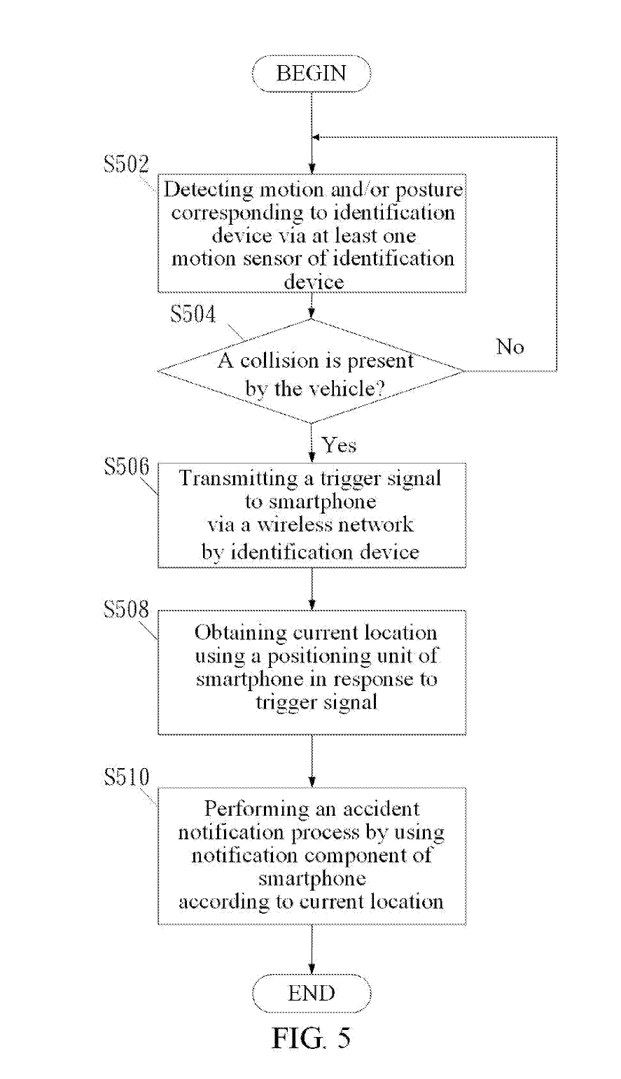

FIG. 5 is a flowchart of another embodiment of a method for accident management for vehicles of the invention.

First, in step S502, a motion and/or a posture corresponding to the identification device is detected via at least one motion sensor of the identification device. Similarly, in some embodiments, the motion sensor may be an accelerometer for generating information of velocity and displacement when the identification device moves. In some embodiments, the motion sensor may be a Gyro sensor for generating information of angular acceleration when the identification device moves. In some embodiments, the motion sensor may be an e-compass for detecting an angle of the identification device in regard to a geographical direction, such as the direction of the North Pole or the South Pole. It is noted that, the above sensors are only examples of the present application, and the present invention is not limited thereto. Any sensor that can detect the posture and/or motion of the identification device can be applied in the present invention. As described, the motion sensor can detect the posture of the identification device. It is understood that, in some embodiments, the posture can be the angular information of the identification device in regard to at least one reference point. In some embodiments, the posture of the identification device can be represented by an angle corresponding to an axis which is vertical to at least one plane of the identification device in regard to a specific direction, such as the gravity direction or the geographical direction. It is noted that, since the identification device is set on the vehicle, the motion and/or posture of the vehicle directly affects the motion and/or posture of the identification device. In step S504, it is determined whether a collision is present by the vehicle according to the data detected by the motion sensor. It is noted that, in some embodiments, a threshold can be set in the motion sensor. When the data detected by the motion sensor is greater than the threshold, it can be determined that a collision is present by the vehicle. When the detected data indicate that a collision is not present by the vehicle (No in step S504), the procedure returns to step S502. When the detected data indicate that a collision is present by the vehicle (Yes in step S504), in step S506, the identification device transmits a trigger signal to the smartphone via a wireless network. It should be noted that, in some embodiments, a connection between the smartphone and the identification device can be established through a wireless network. It should be noted that, in some embodiments, the identification device can broadcast its identification data through the wireless network, and the smartphone can establish a connection with the identification device through the wireless network according to the identification data corresponding to the identification device. Next, in step S508, in response to the trigger signal, current location is obtained by using a positioning unit of the smartphone. As mentioned above, the positioning unit can communicate with at least one satellite to obtain the location corresponding to the smartphone, such as its latitude and longitude coordinates. In some embodiments, a specific place may be obtained based on a specific location and map data. In step S510, an accident notification process is performed by using a notification component of the smartphone according to the current location obtained by the positioning unit.

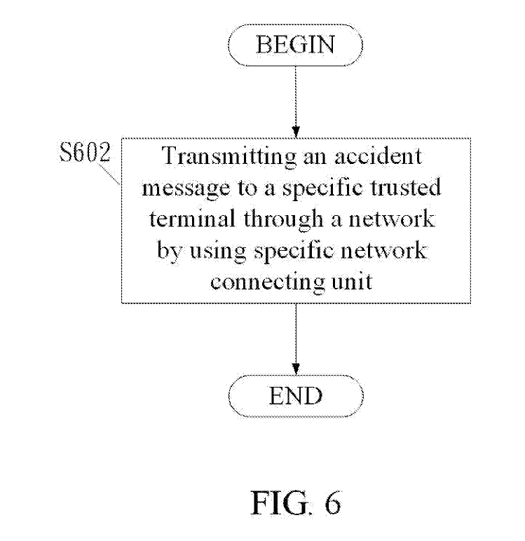

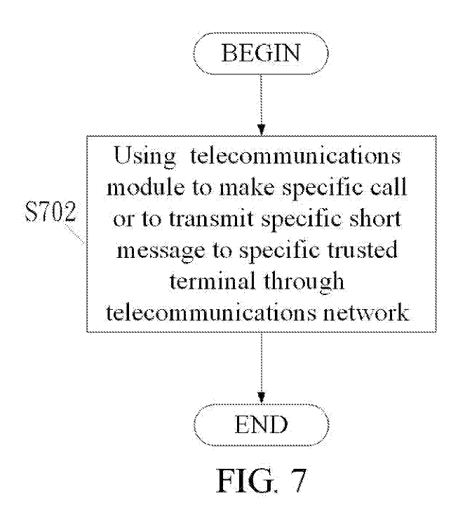

FIG. 6 is a flowchart of an embodiment of a method for accident notification of the invention. In this embodiment, the notification component may include a specific network connecting unit for connecting to the Internet. In step S602, an accident message is transmitted to a specific trusted terminal through a network by using the specific network connecting unit. FIG. 7 is a flowchart of another embodiment of a method for accident notification of the invention. In this embodiment, the notification component may include a telecommunications module for connecting to a telecommunications network of a telecom service provider. In step S702, the telecommunications module is used to make a specific call through a telecommunications network or to transmit a specific short message to a specific trusted terminal. It should be noted that, the above methods for accident notification are only examples of the present application, and the present invention is not limited thereto.

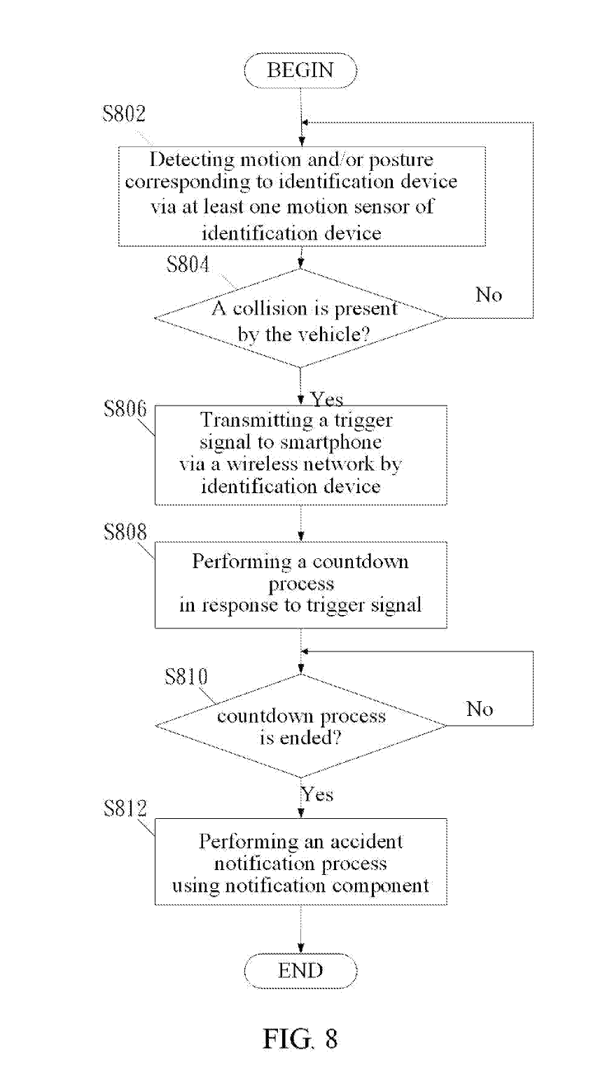

FIG. 8 is a flowchart of another embodiment of a method for accident management for vehicles of the invention.

First, in step S802, a motion and/or a posture corresponding to the identification device is detected via at least one motion sensor of the identification device. Similarly, in some embodiments, the motion sensor may be an accelerometer for generating information of velocity and displacement when the identification device moves. In some embodiments, the motion sensor may be a Gyro sensor for generating information of angular acceleration when the identification device moves. In some embodiments, the motion sensor may be an e-compass for detecting an angle of the identification device in regard to a geographical direction, such as the direction of the North Pole or the South Pole. It is noted that, the above sensors are only examples of the present application, and the present invention is not limited thereto. Any sensor that can detect the posture and/or motion of the identification device can be applied in the present invention. As described, the motion sensor can detect the posture of the identification device. It is understood that, in some embodiments, the posture can be the angular information of the identification device in regard to at least one reference point. In some embodiments, the posture of the identification device can be represented by an angle corresponding to an axis which is vertical to at least one plane of the identification device in regard to a specific direction, such as the gravity direction or the geographical direction. It is noted that, since the identification device is set on the vehicle, the motion and/or posture of the vehicle directly affects the motion and/or posture of the identification device. In step S804, it is determined whether a collision is present by the vehicle according to the data detected by the motion sensor. It is noted that, in some embodiments, a threshold can be set in the motion sensor. When the data detected by the motion sensor is greater than the threshold, it can be determined that a collision is present by the vehicle. When the detected data indicate that a collision is not present by the vehicle (No in step S804), the procedure returns to step S802. When the detected data indicate that a collision is present by the vehicle (Yes in step S804), in step S806, the identification device transmits a trigger signal to the smartphone via a wireless network. Similarly, in some embodiments, a connection between the smartphone and the identification device can be established through a wireless network. It should be noted that, in some embodiments, the identification device can broadcast its identification data through the wireless network, and the smartphone can establish a connection with the identification device through the wireless network according to the identification data corresponding to the identification device. Next, in step S808, in response to the trigger signal, a countdown process is performed. For example, a countdown process may start counting from a predetermined number of seconds, such as 30 seconds. In step S810, it is determined whether the countdown process has been ended. When the countdown process has not been ended (No in step S810), the determination in step S810 is continued. When the countdown operation process has been ended (Yes in step S810), in step S812, an accident notification process is performed by using a notification component of the smartphone. Similarly, in some embodiments, the accident notification process can be performed by transmitting an accident message to a specific trusted terminal over a network. In some embodiments, the accident notification process can be performed by making a specific call through a telecommunications network or transmitting a specific short message to a specific trusted terminal over the telecommunications network. It should be noted that, the above methods for accident notification are only examples of the present application, and the present invention is not limited thereto.

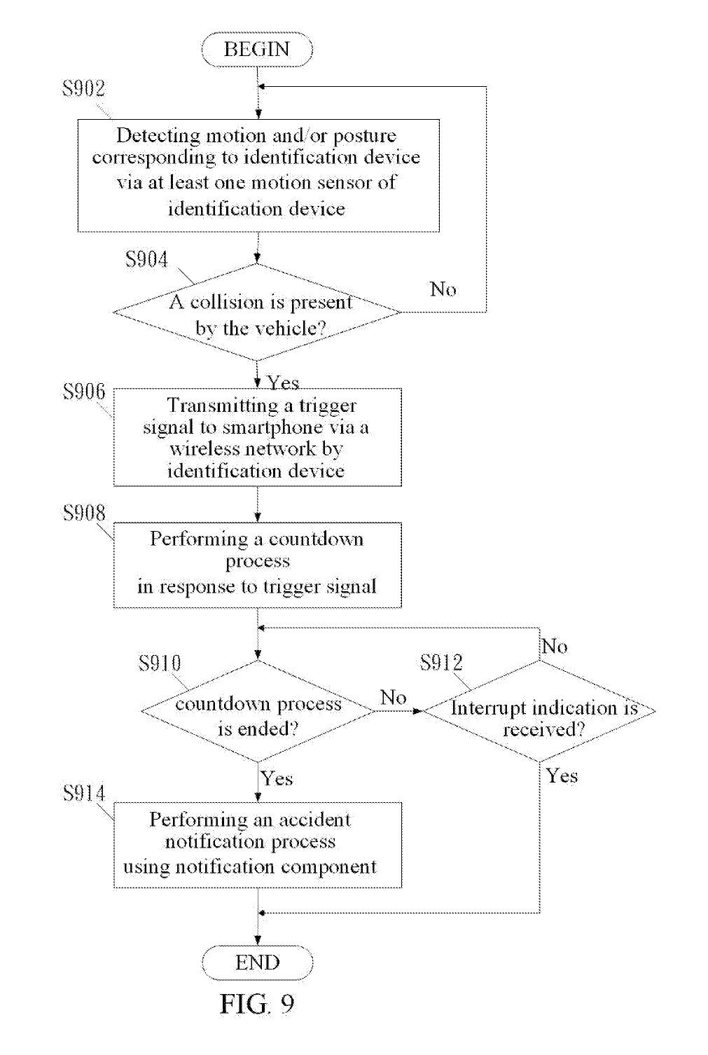

FIG. 9 is a flowchart of another embodiment of a method for accident management for vehicles of the invention.

First, in step S902, a motion and/or a posture corresponding to the identification device is detected via at least one motion sensor of the identification device. Similarly, in some embodiments, the motion sensor may be an accelerometer for generating information of velocity and displacement when the identification device moves. In some embodiments, the motion sensor may be a Gyro sensor for generating information of angular acceleration when the identification device moves. In some embodiments, the motion sensor may be an e-compass for detecting an angle of the identification device in regard to a geographical direction, such as the direction of the North Pole or the South Pole. It is noted that, the above sensors are only examples of the present application, and the present invention is not limited thereto. Any sensor that can detect the posture and/or motion of the identification device can be applied in the present invention. As described, the motion sensor can detect the posture of the identification device. It is understood that, in some embodiments, the posture can be the angular information of the identification device in regard to at least one reference point. In some embodiments, the posture of the identification device can be represented by an angle corresponding to an axis which is vertical to at least one plane of the identification device in regard to a specific direction, such as the gravity direction or the geographical direction. It is noted that, since the identification device is set on the vehicle, the motion and/or posture of the vehicle directly affects the motion and/or posture of the identification device. In step S904, it is determined whether a collision is present by the vehicle according to the data detected by the motion sensor. It is noted that, in some embodiments, a threshold can be set in the motion sensor. When the data detected by the motion sensor is greater than the threshold, it can be determined that a collision is present by the vehicle. When the detected data indicate that a collision is not present by the vehicle (No in step S904), the procedure returns to step S902. When the detected data indicate that a collision is present by the vehicle (Yes in step S904), in step S906, the identification device transmits a trigger signal to the smartphone via a wireless network. Similarly, in some embodiments, a connection between the smartphone and the identification device can be established through a wireless network. It should be noted that, in some embodiments, the identification device can broadcast its identification data through the wireless network, and the smartphone can establish a connection with the identification device through the wireless network according to the identification data corresponding to the identification device. Next, in step S908, in response to the trigger signal, a countdown process is performed. Similarly, in one embodiment, a countdown process may start counting from a predetermined number of seconds, such as 30 seconds. In step S910, it is determined whether the countdown process has been ended. When the countdown process has not been ended (No in step S910), in step S912, it is determined whether an interrupt indication has been received. It should be noted that, in some embodiments, the smartphone may display the countdown process through a user interface by using a display unit. The aforementioned interrupt indication may be received through an input unit of the smartphone, such as a touch screen. When the interrupt indication has not been received (No in step S912), the procedure returns to step S910. When the interrupt instruction has been received (Yes in step S912), the procedure ends. When the countdown process has been ended (Yes in step S910), in step S914, an accident notification process is performed by using a notification component of the smartphone. Similarly, in some embodiments, the accident notification process can be performed by transmitting an accident message to a specific trusted terminal over a network. In some embodiments, the accident notification process can be performed by making a specific call through a telecommunications network or transmitting a specific short message to a specific trusted terminal over the telecommunications network. It should be noted that, the above methods for accident notification are only examples of the present application, and the present invention is not limited thereto.

Therefore, the methods and systems for accident management for vehicles of the present invention can utilize a smartphone and an identification device set on the vehicle to perform an accident notification process of the vehicle, thereby increasing the diversity of vehicle accident management and improving the safety of the vehicle and driving.

Methods for accident management for vehicles, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A system for accident management for vehicles, comprising:
an identification device set on a vehicle, comprising:
a first wireless network connecting unit;
at least one motion sensor configured to detect a motion or posture of the identification device; and
a controller coupled to the first wireless connecting unit and the motion sensor, configured to determine whether a collision is present by the vehicle according to the data detected by the motion sensor, and transmit a trigger signal via a wireless network using the first wireless connecting unit when the detected data indicates that the collision is present by the vehicle; and
a smartphone, comprising:
a second wireless network connecting unit;
a notification component; and
a processor coupled to the second wireless network connecting unit and the notification component, configured to connect to the identification device through the wireless network using the second wireless network connecting unit and perform an accident notification process by using the notification component when receiving the trigger signal from the identification device through the wireless network.

2. The method of claim 1, wherein the notification component comprises a specific network connecting unit, and the accident notification process is performed by using the specific network connecting unit to transmit an accident message through a network to a specific trusted terminal.

3. The method of claim 1, wherein the notification component comprises a telecommunications module, and the accident notification process is performed by using the telecommunications module to make a specific call or transmit a specific message to a specific trusted terminal through a telecommunications network.

4. The method of claim 1, wherein the processor of the smartphone performs a countdown process when receiving the trigger signal from the identification device through the wireless network, and uses the notification device to perform the accident notification process after the countdown process is ended.

5. The method of claim 4, wherein the processor of the smartphone further displays the countdown process through a user interface by using a display unit, determines whether an interrupt indication is received before the end of the countdown process, and cancels the accident notification process when the interrupt indication is received before the end of the countdown process.

6. The method of claim 1, wherein the smartphone further comprises a positioning unit, and the processor of the smart phone uses the positioning unit to obtain current location when receiving the trigger signal from the identification device through the wireless network, and performs the accident notification process using the notification component according to the current location.

7. A method for accident management for vehicles for use in an identification device set on a vehicle and a smartphone, comprising:
detecting a motion or posture of the identification device via at least one motion sensor of the identification device;
determining whether a collision is present by the vehicle according to the data detected by the motion sensor;
transmitting a trigger signal to the smartphone via a wireless network by the identification device when the detected data indicates that a collision is present by the vehicle; and
performing an accident notification process by using a notification component of the smartphone in response to the trigger signal.

8. The method of claim 7, wherein the notification component comprises a specific network connecting unit, and the accident notification process comprises using the specific network connecting unit to transmit an accident message through a network to a specific trusted terminal.

9. The method of claim 7, wherein the notification component comprises a telecommunications module, and the accident notification process comprises using the telecommunications module to make a specific call or transmit a specific message to a specific trusted terminal through a telecommunications network.

10. The method of claim 7, further comprising:
performing a countdown process when the processor of the smartphone receives the trigger signal from the identification device through the wireless network; and
using the notification device to perform the accident notification process after the countdown process is ended.

11. The method of claim 10, further comprising:
displays the countdown process through a user interface by using a display unit;
determining whether an interrupt indication is received before the end of the countdown process; and
cancelling the accident notification process when the interrupt indication is received before the end of the countdown process.

12. The method of claim 7, further comprising using a positioning unit to obtain current location when the smartphone receives the trigger signal from the identification device through the wireless network, and performing the accident notification process using the notification component according to the current location.

13. A machine-readable storage medium comprising a computer program, which, when executed, causes a device to perform a method for accident management for vehicles, wherein the method comprises:
detecting a motion or posture of an identification device via at least one motion sensor of the identification device, wherein the identification device is set on a vehicle;
determining whether a collision is present by the vehicle according to the data detected by the motion sensor;
transmitting a trigger signal to a smartphone via a wireless network by the identification device when the detected data indicates that a collision is present by the vehicle; and
performing an accident notification process by using a notification component of the smartphone in response to the trigger signal.
